(19) United States
(12) Patent Application Publication
(10) Pub. No.: US 2026/0203310 A1
(43) Pub. Date: Jul. 16, 2026

(54) METHOD FOR DIGITIZING, CUSTOMIZING, AND DISPLAYING A LISTING OF LOCATION-BASED INFORMATION

(71) Applicants: Benjamin Tett, Arlington, VA (US); Jaimey Bembry, Arlington, VA (US)

(72) Inventors: Benjamin Tett, Arlington, VA (US); Jaimey Bembry, Arlington, VA (US)

(21) Appl. No.: 18/831,401

(22) Filed: Jan. 14, 2025

(51) Int. Cl. G06F 16/28; G06F 7/08; G06F 40/18

(52) U.S. Cl. CPC G06F 16/287; G06F 7/08; G06F 40/18

(57) ABSTRACT

A method for creating and managing a digitized curated list. The list is then distributed to list users that the list owner wishes to grant access. The list user's location is of paramount importance. Based on that location, the user list will vary from user to user. Further, the method is dynamic so that as a specific user's location changes, that user's list will change accordingly in real-time.

### FIELD OF THE INVENTION

This invention relates generally to systems and methods for creating, managing, and utilizing location-based digital lists for events and venues. Specifically, it is designed to digitize static and curated data lists (e.g., paper or non-paper based and electronic formats), allowing users to create virtually any type of digital guide. Further, it provides a system leveraging geospatial data, customizable filters, and real-time user interactions to enable users to access curated information tailored to their location and preferences.

### BACKGROUND OF THE INVENTION

With the rise of social media platforms like Instagram, Facebook, and TikTok, individuals frequently rely on these platforms to discover places to eat, visit, and experience. However, a significant percentage of users do not utilize social media for recommendations, instead depending on sources like family, colleagues, event planners, or local lodging providers such as hotels, Airbnbs, or cruise ships.

Traditional methods of recommending places—like paper based, non-paper based and electric lists—may contain outdated information and are static, disconnected from real-time user needs, and often inaccessible to the recommended businesses themselves. Managing and navigating location-specific events and venues is often cumbersome and disorganized. Existing systems lack the ability to efficiently process and present geographically-relevant data in a customizable and searchable manner. There is a need for a streamlined system that allows list owners to create, manage, and distribute digital lists that are location-aware and user-configurable, enabling real-time and precise access. to information.

The present invention is designed to provide a system and method for creating, managing, and utilizing location-based digital lists for events and venues. The system allows list owners to upload structured data, which is processed into geospatially and temporally aware records. Users can interact with these lists through proximity-based searches, dynamically filtered and sorted by location, time, and keywords. The system further includes tools for editing and customizing list parameters to enhance usability and accessibility.

### SUMMARY OF THE INVENTION

A method for curating and digitizing a listing of desired festivities is provided. This method is accessible through any internet-enabled device without requiring additional applications or installations.

The method comprises a cloud-based platform that ingests curated data sets (static lists) and converts them into dynamic, interactive lists accessible via a web link. Each object in the list is assigned metadata, including geolocation coordinates, description, and links for navigation. The method generates links, each with a unique identifier, ensuring each link is tailored to specific needs. Each unique identifier guarantees secure and seamless access and can be used privately for internal purposes, shared among a select group for collaborative access, or made public to reach a broader audience.

A list owner submits a file using the method by way of an upload link. That file is a spreadsheet. The spreadsheet has 17 columns, each representing a data element for the method list entry:
i. Column 1—Name
ii. Column 2—Categorical Classification List Designator
iii. Column 3—City
iv. Column 4—State
v. Column 5—Country
vi. Column 6—Description
vii. Column 7—Hidden Description
viii. Column 8—Start Date of the list entry
ix. Column 9—End Date of the list entry
x. Column 10—Start Time of the list entry
xi. Column 11—End Tim of the list entry
xii. Column 12—Entry Location Name (Venue)
xiii. Column 13—Address
xiv. Column 14—Postal Code
xv. Column 15—Website
xvi. Column 16—Auxiliary Link
xvii. Column 17—Auxiliary Link Title

To create a list using the method, a list owner would: Create a new Festivity (sometimes referred to as an “object”) to represent the row in the database; Create and store a new Category for the list based on the name of the category. (The category will have a default radius of 200 miles that is configurable and can be changed while the list is live which will restrict the visibility of the list based on the location of the computational device using the list. The category will have a Universally Unique Identifier (UUID)); Associate the festivity with the category and store this association in the database; Add the start time information to the start date information and store that in the festivity record; Add the end time to the end date and store that information in the festivity record; Add the city, state, country, venue name, website, auxiliary link, title, hidden description, description, postal code, and address to the new festivity object; Create a separate record for the location name (venue). Add it to the venue table if a record for that venue does not exist; That record will contain all the name and address information for the venue; Associate that venue with the festivity; Lookup the geospatial information for the address provided in terms of the latitude and longitude; Add the latitude and longitude information to both the festivity record and the venue record; Store the festivity, venue and association information to the database. At this point the master list is established in the system of the method.

A list user can now search the master list. A list user would activate the link generated by the method on a computation device (Smartphone, Tablet, Computer) while providing the user's latitude and longitude. The system receives the request. If the user request has a latitude and longitude of 0, the method will use the latitude and longitude associated with the registered address of the Internet Protocol (IP) address sourcing the request. Search parameters are now collected based on the data stored for the category list: 1) Category_UUID, 2)Search radius ; 3) Current date and time, and 4) Default end time to 12 months from the current date. A distance map is created with the key being the festivity Identification (ID) and the object being a proximity festivity data transfer object. The database is queried a listing of all the festivities in the list designated by the category UUID is obtained. The system create and empties hashmap to hold all the festivity IDs that will be within the range of proximity. The date search range query are built. The Database is queried using the Haversine Sines Approximation combined with the date search range query. For each member of the results set, a proximity festivity Data Transfer Object (DTO) object which will have an ID and a distance from the requestor's geolocation is created. The proximity festivity DTO to the distance map is added. The proximity festivity DTO identification-ID is added to a proximity ID hash map. The Proximity Search conditional is now complete. Next, the method takes the intersection of the IDs in the list of festivities matching the category, and the set of festivities returned from the proximity and date range query and put these in a list. The approved predicate to the list of festivities is applied. This will eliminate all festivities in the list that do not have the approved flag set to true. (This allows the list owner to restrict visibility of the items in their master list by simply setting this flag). The keyword predicate is applied, which will eliminate any item from the list that does not contain at least one of the keywords in the title, description or hidden description. (This allows the list owner to allow list users to search within the list for specific information about the items in the list). The final list of items is sorted according to start date first and then in order of distance. The user list (the list of items represented in the digitized list) is generated.

The master list can be edited by editing the named category that represents the master list. The Radius of Interest defines the distance in proximity to a user's computational device. If set to 200, the user will only see items on the list that are within 200 miles of the users'computational device. The show start time allows the list owner to show a user the activation time of the list items. After this time, the list items are viewable by the user. The show end time-Allows the list owner to show the user the deactivation time of the list items. After this time the list items are no longer viewable by the list users.

It is a primary objective of the present invention to provide a method for creating a list, leveraging location-based services and a list creation algorithm utilizing a distance formula based on the law of haversines to index the list according to distance. More particularly, it is an objective of the present invention to provide to a list user a link that provides real-time, proximity-based sorting of locations, venues, and points of interest.

It is another objective of the present invention to provide a method wherein a list owner is able to restrict visibility of certain listed festivities.

It is still another objective of the present invention to provide a method wherein the list of festivities is sorted according to start date first and then in order of distance.

It is still another objective of the present invention to provide a method that removes any festivities that have expired.

The method is useful for entities (list owners) who wish to create lists to be distributed (e.g., internet link or QR code) to list users. The list generated for the list owner (i.e., the master list) provides the basis for the user list. The list provided to individual users takes into account the user's location. Thus, users in different locations will receive different lists. Further, the method is dynamic so that as a specific user's location changes, that user's list will change accordingly in real-time.

The list owner accesses the process'import functionality and inputs values for each festivity. Once all values have been entered, the list is sorted, creating the master list. At the list owner's discretion, access to the master list is provided to list users. A list user's location is determined. Based on the list user's location, a user list is created.

### BRIEF DESCRIPTION OF THE DRAWINGS

Preferred and alternative embodiments of the present invention are described in detail below with reference to the following drawings:

FIG. 1 shows the relationship between a list owner and festivities to be listed.

FIG. 2 shows a flow chart illustrating the method of the present invention.

FIG. 3 shows a flow chart detailing the method of processing a single categorical metadata record, a step shown in FIG. 2.

FIG. 4 shows a flow chart of an aspect of the process illustrated in FIG. 3.

FIG. 5 shows the basic relationship between a list owner, the data to be processed, and a list user.

FIG. 6 shows a flow chart illustrating the method as it relates to a list user.

FIG. 7 shows the relationships between festivities and multiple list users.

FIG. 8 identifies the mathematical equations used to determine the distance values of festivities as they relate to a list user.

### DETAILED DESCRIPTION OF THE PREFERRED EMBODIMENT

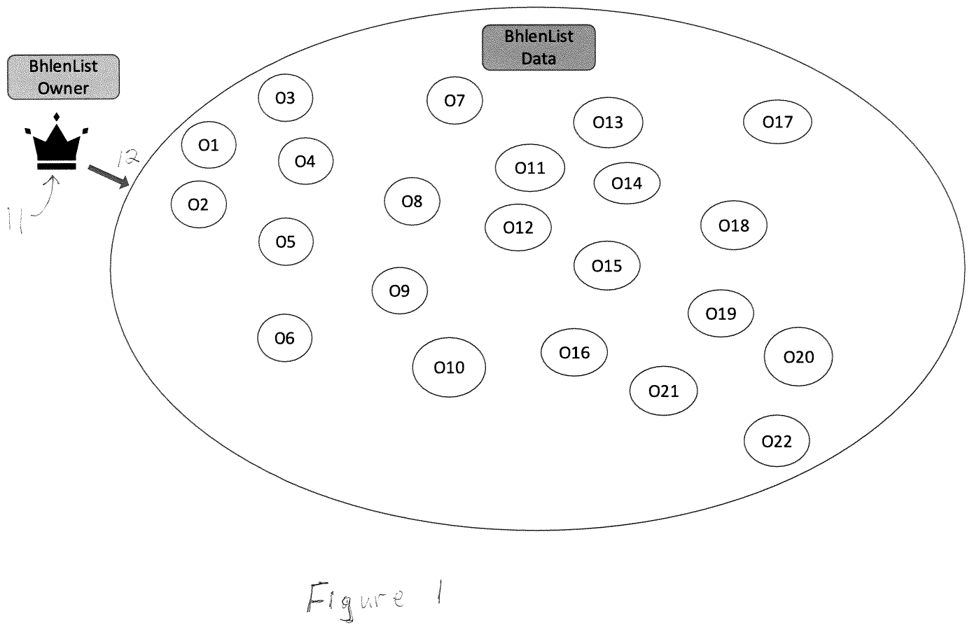

Referring to FIG. 1, a list owner 11 inputs information for selected festivities 12.

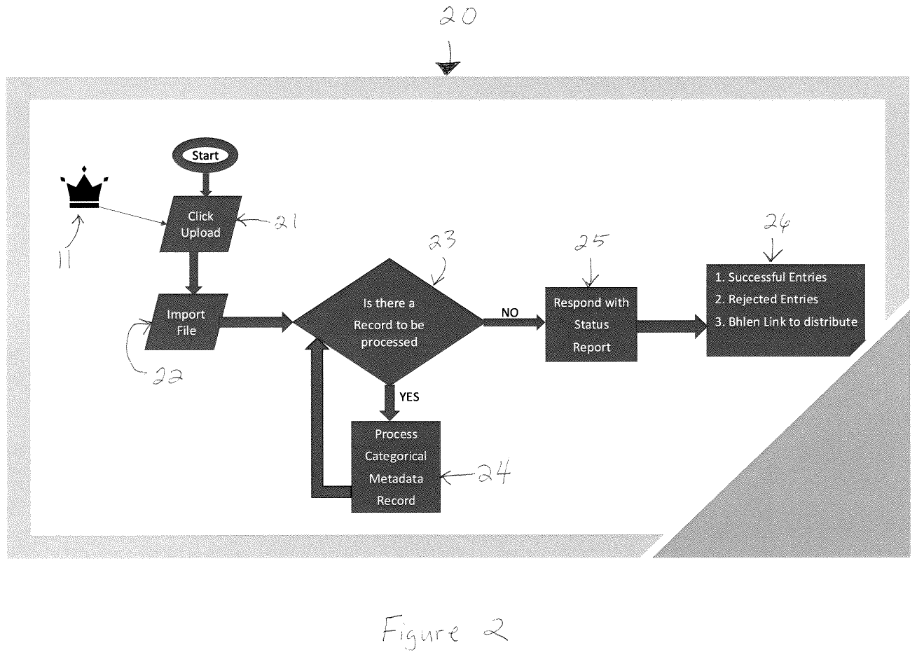

Referring to FIG. 2, a list owner 11 begins the method 20 of creating a master list by accessing the process'import functionality 21. The list owner 11 inputs data for selected festivities 12 and a file is imported 22. Once all records have been imported 22, a determination is made as to whether there is a record to be processed 23. If “Yes”, then any unprocessed records are processed 24. The record processing determination 23 is made again. Once the determination is “No”, a status report 25 is generated to that effect. The master list is then generated 26.

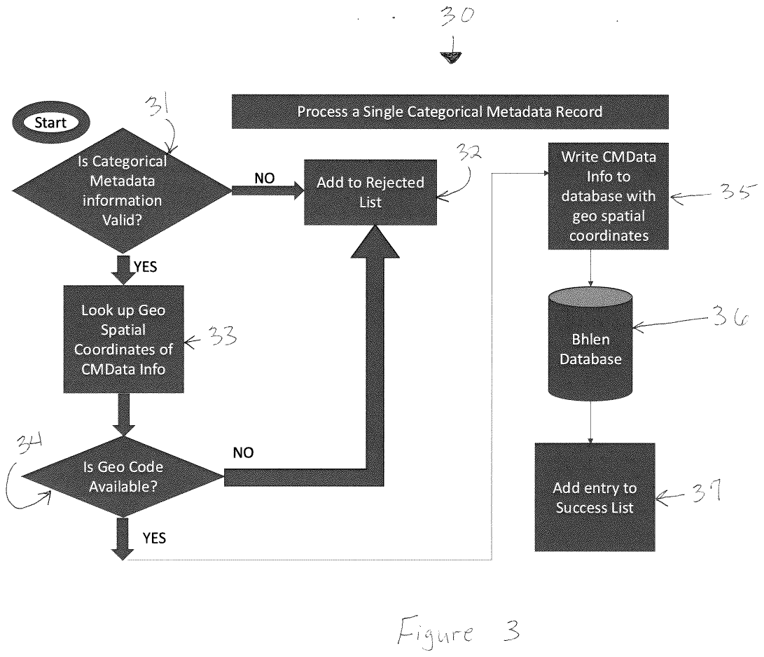

Referring to FIG. 3, a method 30 of processing each categorical metadata record is shown. A determination 31 is made as to whether a record is valid. If the determination is “No”, the record is added to a Rejected List 32. If the determination is “Yes”, an attempt 33 is made to retrieve the geospatial coordinates of the record. A determination 34 is made as to whether a geo code is available. If the determination is “No”, the record is added to a Rejected List 32. If the determination is “Yes”, the information is added to a database 35 with the corresponding geospatial coordinates. The corresponding record is added to a master database 36. A master list is created 37 from the records included in the database.

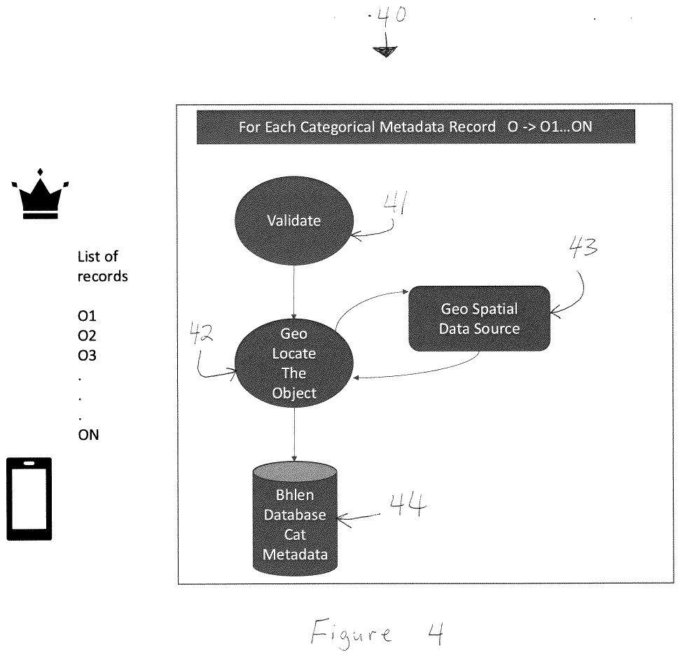

As is shown in FIG. 4, a method 40 of processing each individual categorical metadata record. As described in relation to FIG. 3, above, a validity determination 41 is made regarding a record. Once the record is validated, the geospatial location of the corresponding festivity is obtained 42. This is accomplished by the system communicating with a geospatial data source 43 (e.g., Google Maps). After acquiring the geospatial location, the record is added to the database 44.

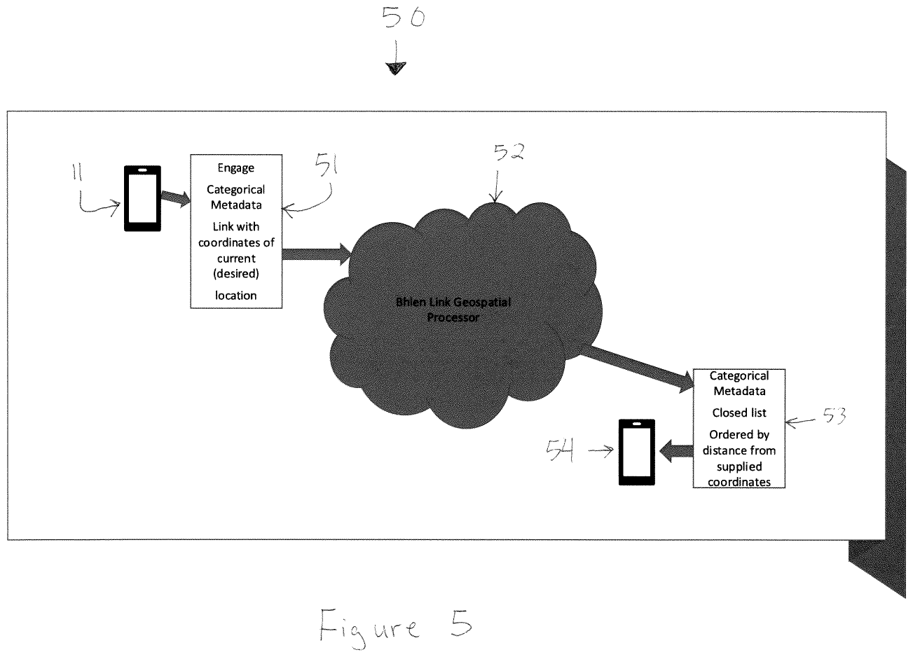

As is shown in FIG. 5, a simplified version 50 of the method 20 starts with list owner 11 accessing the system. The list owner 11 inputs data 51 into the system. The inputed data is then processed by the system's geospatial processor 52. A master list is produced 53. From the master list, an ordered user list is generated and is provided to the list user 54.

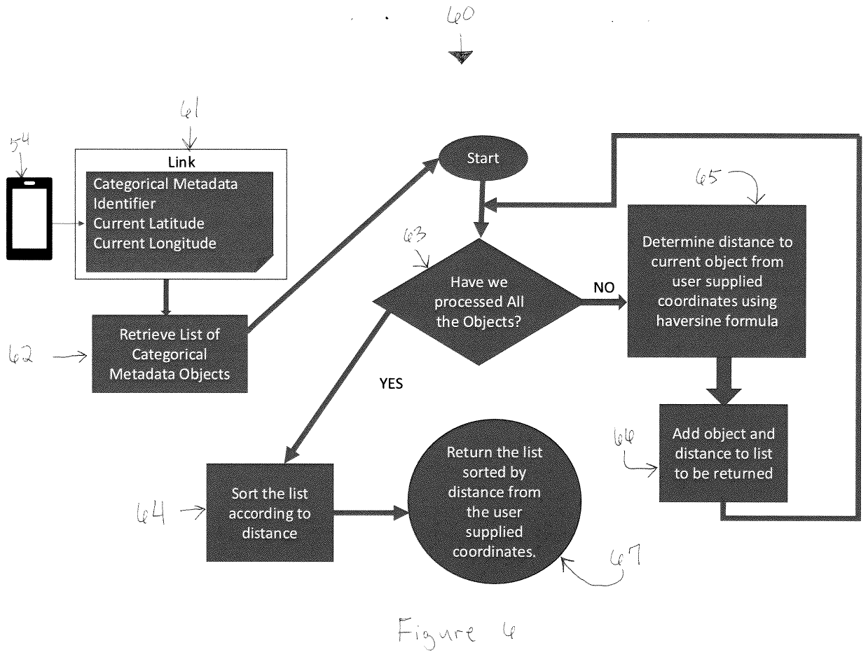

As is shown in FIG. 6, a method 60 is provided so that a list user can input his or her location and receive a user list based on that location. A list user 54 is granted access 61 to the system. The list user inputs his or her location. The master list is retrieved 62. A determination is made 63 as to whether all objects have been processed. If the determination is “Yes, the list is sorted 64 according to the distance between the festivity and the user. If the determination is “No”, the distance between the festivity and the user is calculated 65 using the haversine formula. Then the object and list are added 66 to the user list. A determination is again made 63 as to whether all objects have been processed. This is repeated until all objects have been processed. Once all objects have been processed, the user list is sorted according to each object's distance from the list user. The user list is finalized 67 and provided to the user.

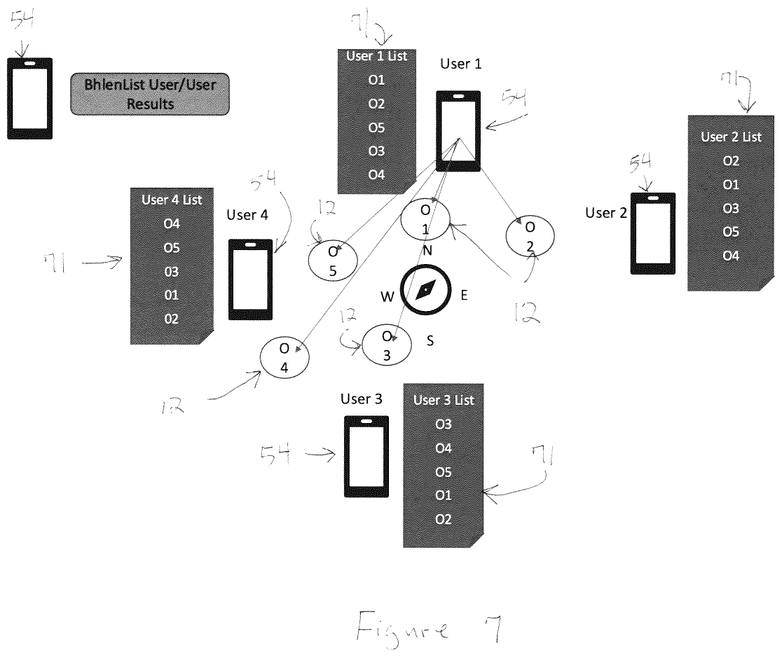

As shown in FIG. 7, different list users 54 receive different lists 71, or differently ordered lists, depending on the respective distances between the list user 54 and various objects 12.

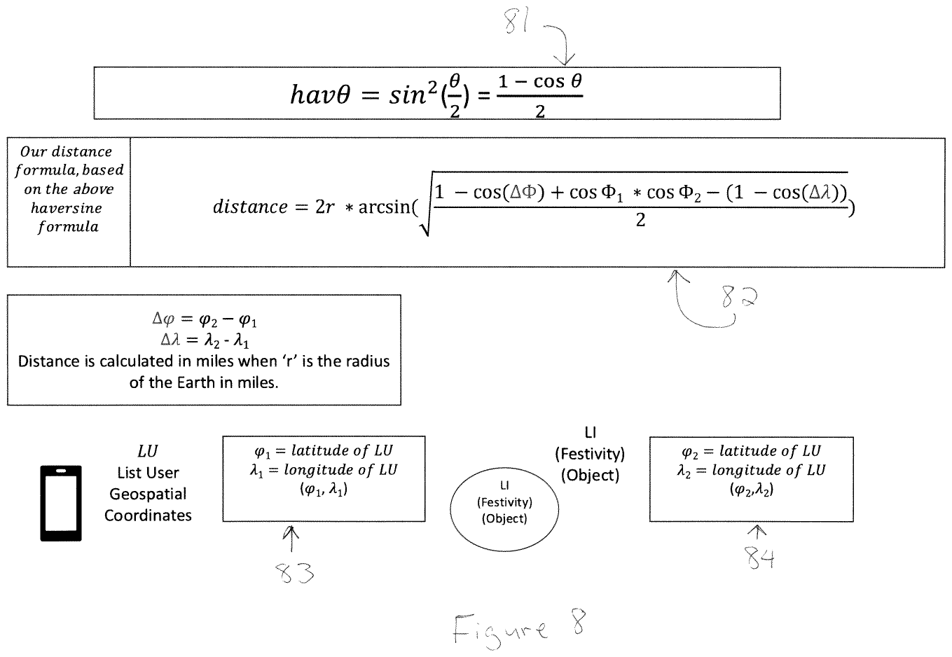

The method of the present invention utilizes the law of haversines. The haversine formula determines the great-circle distance between two points on a sphere given their respective latitudes and longitudes. As shown in FIG. 8, the method utilizes the haversine function 81. The value for Θ is calculated using distance (the distance between the festivity and the list user) and radius (the radius of the earth). Distance is calculated 82 using the archaversine. The geospatial coordinates 83 of the list user are the user's latitude and longitude. The geospatial coordinates 84 of the festivity are the festivity's latitude and longitude.

While the preferred embodiment of the invention has been described, various alternative embodiments of the invention are possible without departing from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A computer-implemented method for generating a geolocation-dependent digital guide, the method comprising:
receiving, from a list owner, a plurality of records, each record comprising a venue or event and associated metadata including latitude, longitude, category, public description, hidden description, start date, and end date;
storing the plurality of records in a structured database;
generating, for each requesting user device, a unique guide identifier (UUID);
receiving, from the user device, a current geolocation;
computing a distance between the user device and each record;
filtering the records by:
(i) selecting only records whose distance is within a preset activation radius,
(ii) selecting only records whose start date and end date include the current date,
(iii) selecting records matching category-or metadata-based filters;
generating a personalized subset of records for the user device; and
transmitting the personalized subset for display as a mobile-first digital guide.

14. The method of claim 13, wherein the festivity information received for each record further includes a Categorical Classification List Designator (CCLD) identifying the curated list or classification to which the festivity belongs.

15. The method of claim 14, wherein the festivity information received for each record further includes geographic address metadata comprising at least a city, state, and country associated with the festivity.

16. The method of claim 15, wherein the festivity information for each record further includes temporal metadata comprising at least a start date or start time and an end date or end time defining the period during which the festivity is active.

17. The method of claim 16, further comprising providing a third party with access to the master list through a digital retrieval mechanism that enables the third party to request generation of a personalized guide based on the master list.

18. The method of claim 17, wherein the access is provided through a network-accessible hyperlink or a machine-readable QR code that encodes a reference to the master list or to a guide identifier (UUID), such that scanning or selecting the code initiates retrieval of data for generating a personalized digital guide.

19. The method of claim 18, further comprising:
(a) receiving, from the third-party user device, current geolocation information;
(b) retrieving, based on the guide identifier (UUID) or access mechanism, the master list of festivity records;
(c) computing, for each record on the master list, a geospatial distance between the user device's current geolocation and the record's latitude and longitude coordinates using a geodesic distance algorithm;
(d) generating a user-specific subset by associating each record with its computed distance value;
(e) sorting the subset using a multi-stage ranking process comprising:
(i) ordering records by start date or temporal relevance; and
(ii) ordering records by proximity to the user device;
(f) generating a personalized digital guide based on the sorted subset; and
(g) displaying the personalized digital guide in a mobile-optimized digital format.

20. The method of claim 19, wherein determining the distance between the user device and each festivity comprises applying a geodesic distance algorithm, including at least the haversine formula.

21. The method of claim 20, further comprising evaluating the temporal metadata for each festivity record to determine whether the current date or time falls outside the record's start or end parameters, and excluding from the personalized guide any record identified as no longer active.

22. A computer-implemented method for generating a curated and digitized listing of festivities, the method comprising:
(a) receiving, from a list owner, festivity information comprising a plurality of metadata fields including a Categorical Classification List Designator (CCLD), city, state, country, start date, and end date, and creating a corresponding structured record for each festivity;
(b) importing the plurality of structured records into a database and processing the records to detect completeness, formatting consistency, or metadata validity;
(c) determining whether any unprocessed records remain and, if so, processing the unprocessed records until all records have been validated;
(d) generating a status indication that all records have been processed and creating a master list comprising the validated records;
(e) providing a third party with access to the master list through a network-accessible link or machine-readable QR code;
(f) receiving, from the third party's device, current geolocation information;
(g) retrieving the master list and computing, for each festivity, a geospatial distance between the third party's device location and the festivity's coordinates using a geodesic distance algorithm;
(h) generating a user-specific subset by associating each festivity with its computed distance value;
(i) sorting the subset using a multi-stage ranking process comprising:
(i) ordering the festivities based on start date or temporal relevance; and
(ii) ordering the festivities based on proximity to the user;
(j) excluding from the subset any festivity whose temporal metadata indicates that it is no longer active; and
(k) displaying the resulting personalized listing of festivities in a digital format on the third party's device.

23. The method of claim 22, wherein access to the master list is provided through a network-accessible hyperlink or a machine-readable QR code that encodes a reference to the festivity guide.

24. The method of claim 23, wherein the distance between the third party and each festivity is computed using a Haversine-based geodesic distance algorithm.
